(19) United States
(12) Patent Application Publication
(10) Pub. No.: US 2024/0200401 A1
(43) Pub. Date: Jun. 20, 2024

(54) Motorized Retractable Screen System

(71) Applicant: Four Season Industries, LLC, Canton, GA (US)

(72) Inventors: Derek D. Melnychuk, Canton, GA (US); Virgolino Carrilho, Greer, SC (US); Steven A. Caputo, Ball Ground, GA (US); Craig J. Cochran, Atlanta, GA (US); Dustin F. Coha, Atlanta, GA (US); Kevin B. Green, Smyrna, GA (US); Kirk W. Charles, Austell, GA (US)

(73) Assignee: Four Season Industries, LLC, Canton, GA (US)

(21) Appl. No.: 18/390,875

(22) Filed: Dec. 20, 2023

Related U.S. Application Data
(60) Provisional application No. 63/609,454, filed on Dec. 13, 2023.
(60) Provisional application No. 63/433,806, filed on Dec. 20, 2022.

(51) Int. Cl. E06B 9/42; E06B 9/54; E06B 9/58; E06B 9/70

(52) U.S. Cl. CPC E06B 9/42; E06B 9/54; E06B 9/581; E06B 9/70

(57) ABSTRACT

A corner tensioning system for a motorized retractable screen system. The corner tensioning system includes a tensioning arm having a first end configured to be operatively connected to a screen of the motorized retractable screen system, a second end configured to be operatively connected to a bottom bar of the motorized retractable screen system, and attachment means for operatively connecting a drive cable of the motorized retractable screen system to the tensioning arm between the first end and the second end.

### CROSS REFERENCE TO RELATED APPLICATIONS

This application claims priority to co-pending U.S. Provisional Application Ser. No. 63/433,806 filed Dec. 20, 2022, and co-pending U.S. Provisional Application Ser. No. 63/609,454 filed Dec. 13, 2023, both being entitled “Motorized Retractable Screen System,” and the entire contents of both being incorporated herein by reference.

### FIELD

This disclosure relates to the field of retractable screen systems. More particularly, this disclosure relates to a motorized retractable screen system having a corner tensioning assembly for maintaining tension of the screen during its movement between the deployed and retracted positions.

### BACKGROUND

Retractable screens are often installed in the openings of framed areas such as doorways, windows, and porched areas. When deployed, the screen acts as a barrier between the inside and outside of the framed area. Current designs use a motor to unwind the screen from an screen axle located at the top of the framed area and rely on gravity to pull the screen downward. However, wind or air pressure differences between the inside and outside of the framed area will often cause binding along the endges of the screen. Binding prevents lowering of the screen while pressure differences exist or otherwise bunches the screen in the system. Wind will also billow material and lift the bottom of the screen when not desired. Further, as these systems rely on gravity to deploy the screens, they only allow the screen to be moved up and down. This limits potential installation opportunities or otherwise makes installation more difficult in certain circumstances in which the requirements of the framed area makes it unfeasible to provide for placement of the components of the system necessary for vertical movement of the screen.

What is needed therefore is a retractable screen system that is designed such that the screen may be deployed without relying on gravity and/or a tensioning system for the retractable screen that maintains sufficient tension on the screen during deployment and retraction of the screen within the framed area.

### SUMMARY

The above and other needs are met by a motorized retractable screen system including a screen axle disposed adjacent a first end of a framed area that is configured to be rotated by a motor; at least one spool operatively connected to the screen axle such that the screen axle and the at least one spool are opereable to rotate together; a cable including a first end and a second end, wherein the first end is at least partially wound around the at least one spool and wherein the cable is run through a series of pulleys between its first end and its second end, the series of pulleys including a first pulley system disposed adjacent the first end of the framed area and a second pulley system disposed adjacent the second end of the framed area; a screen including a first end operatively connected to the screen axle, a second end operatively connected to a bottom bar, a first side, and a second side; and a corner tensioning system including a tensioning arm having a first end configured to be operatively connected to a corner of the first side of the screen, a second end configured to be operatively connected to a first side of the bottom bar, and attachment means for operatively connecting to the second end of the cable. In operation, the screen axle is operable to be rotated in either a first direction or a second direction by the motor such that the cable is operable to pull the bottom bar at the second end of the screen between a deployed position and a retracted position while the corner tensioning system maintains downward and outward tension on the screen.

According to certain embodiments, the corner of the first side of the screen includes a stirrup configured to receive the first end of the tensioning arm for operatively connecting the first end of the tensioning arm to the corner of the first side of the screen.

According to certain embodiments, the attachment means is configured to provide for a pivotable connection between the second end of the cable and the tensioning arm. In some embodiments, the tensioning arm includes a plurality of attachment positions for altering the position of the pivotable connection between the second end of the cable and the tensioning arm. In some embodiments, the attachment means includes a clevis connection for pivotally connecting the second end of the cable to the tensioning arm.

According to certain embodiments, the corner tensioning system includes a biasing means for providing a biased outward force to the second end of the tensioning arm. In some embodiments, the corner tensioning system further includes a housing configured to be disposed within the bottom bar and a carriage disposed within the housing that is operable to move laterally with respect to the bottom bar and housing, wherein the biasing means is operatively connected to the carriage and the second end of the tensioning arm is operatively connected to the carriage such that the biasing means provides the biased outward force to the second end of the tensioning arm via the carriage. According to some embodiments, the second end of the tensioning arm is pivotally connected to a first end of the carriage. According to some embodiments, the second end of the tensioning arm includes a first stop edge and a second stop edge and the first end of the carriage includes a corresponding first stop edge and a second stop edge, and wherein the first stop edge of the tensioning arm is dimensioned and configured to engage the first stop edge of the carriage to limit movement of the tensioning arm in a first rotational direction and the second stop edge of the tensioning arm is dimensioned and configured to engage the second stop edge of the carriage to limit movement of the tensioning arm in a second rotational direction opposite the first rotational direction.

According to certain embodiments, the corner tensioning system further includes: a housing configured to be disposed within the bottom bar, the second end of the tensioning arm being secured within the housing such that the tensioning arm is operable to move laterally with respect to the housing and the bottom bar; and a roller spool operatively connected to the housing, the roller spool including a plurality of gear teeth configured to mesh with corresponding gear teeth of the tensioning arm. According to this embodiment, the roller spool is the attachment means for operatively connecting the second end of the cable to the tensioning arm and wherein a tension of the cable creates a torque on the roller spool resulting in a rack-and-pinion action between the gear teeth of the roller spool and the gear teeth of the tensioning arm such that the tensioning arm is biased outward to maintain tension on the screen.

According to another embodiment of the disclosure, a corner tensioning system for a motorized retractable screen system includes a tensioning arm having a first end configured to be operatively connected to a screen of the motorized retractable screen system, a second end configured to be operatively connected to a bottom bar of the motorized retractable screen system, and attachment means for operatively connecting a drive cable of the motorized retractable screen system to the tensioning arm between the first end and the second end.

According to certain embodiments, the attachment means is configured to provide for a pivotable connection between the drive cable and the tensioning arm. In some embodiments, the tensioning arm includes a plurality of attachment positions for altering the position of the pivotable connection between the drive cable and the tensioning arm.

According to certain embodiments, the attachment means includes a clevis connection for pivotally connecting the drive cable to the tensioning arm.

According to certain embodiments, the corner tensioning system includes a biasing means for providing a biased outward force to the second end of the tensioning arm. In some embodiments, the corner tensioning system further includes a housing configured to be disposed within the bottom bar and a carriage disposed within the housing that is operable to move laterally with respect to the bottom bar and housing, wherein the biasing means is operatively connected to the carriage and the second end of the tensioning arm is operatively connected to the carriage such that the biasing means provides the biased outward force to the second end of the tensioning arm via the carriage. In some embodiments, the second end of the tensioning arm is pivotally connected to a first end of the carriage. In some embodiments, the second end of the tensioning arm includes a first stop edge and a second stop edge and the first end of the carriage includes a corresponding first stop edge and a second stop edge, and wherein the first stop edge of the tensioning arm is dimensioned and configured to engage the first stop edge of the carriage to limit movement of the tensioning arm in a first rotational direction and the second stop edge of the tensioning arm is dimensioned and configured to engage the second stop edge of the carriage to limit movement of the tensioning arm in a second rotational direction opposite the first rotational direction.

According to certain embodiments, the corner tensioning system includes a housing configured to be disposed within the bottom bar, the second end of the tensioning arm being secured within the housing such that the tensioning arm is operable to move laterally with respect to the housing and the bottom bar; and a roller spool operatively connected to the housing, the roller spool including a plurality of gear teeth configured to mesh with corresponding gear teeth of the tensioning arm. According to this embodiment, the roller spool is the attachment means for operatively connecting the drive cable to the tensioning arm and a tension of the cable creates a torque on the roller spool resulting in a rack-and-pinion action between the gear teeth of the roller spool and the gear teeth of the tensioning arm such that the tensioning arm is biased outward to maintain tension on the screen.

### BRIEF DESCRIPTION OF THE DRAWINGS

Other embodiments of the invention will become apparent by reference to the detailed description in conjunction with the figures, wherein elements are not to scale so as to more clearly show the details, wherein like reference numbers indicate like elements throughout the several views, and wherein:

FIG. 1 depicts a motorized retractable screen system installed in a framed area according to one embodiment of the present disclosure.

FIG. 2 depicts the components of the first side of the motorized retractable screen system of FIG. 1 according to one embodiment of the disclosure.

FIG. 3 depicts the components of the first side of a motorized retractable screen system according to one embodiment of the disclosure.

FIG. 4 depicts a perspective view of a corner tensioning system for the motorized retractable screen system of FIG. 3 according to one embodiment of the disclosure.

FIG. 5 depicts an enlarged partial sectional view of a corner tensioning system for the motorized retractable screen system of FIG. 3 with the screen in the fully deployed position according to one embodiment of the disclosure.

FIG. 6 depicts an enlarged partial sectional view of the corner tensioning system of FIG. 5 with the screen in an intermediate retracted position according to one embodiment of the disclosure.

FIG. 7 depicts a side partial sectional view of the corner tensioning system of FIGS. 3-6 with the series of directional forces applied by the tensioning system depicted according to one embodiment of the disclosure.

FIG. 8 depicts a side partial sectional view of the corner tensioning system with the tensioning arm limited in its upward travel according to one embodiment of the disclosure.

FIG. 9 depicts a side partial sectional view of the corner tensioning system with the tensioning arm limited in its downward travel according to one embodiment of the disclosure.

FIG. 10 depicts a side partial sectional view of the corner tensioning system with the tensioning arm having multiple cable attachment positions and an optional aperture at its first end for attaching to the screen according to one embodiment of the disclosure.

FIG. 11 depicts a first side perspective view of a corner tensioning system according to one embodiment of the disclosure.

FIG. 12 depicts a second side perspective view of the corner tensioning system of FIG. 11 according to one embodiment of the disclosure.

FIG. 13 depicts an enlarged partial sectional view of the corner tensioning system of FIGS. 11-12 for a motorized retractable screen system with the screen in the fully deployed position according to one embodiment of the disclosure.

### DETAILED DESCRIPTION

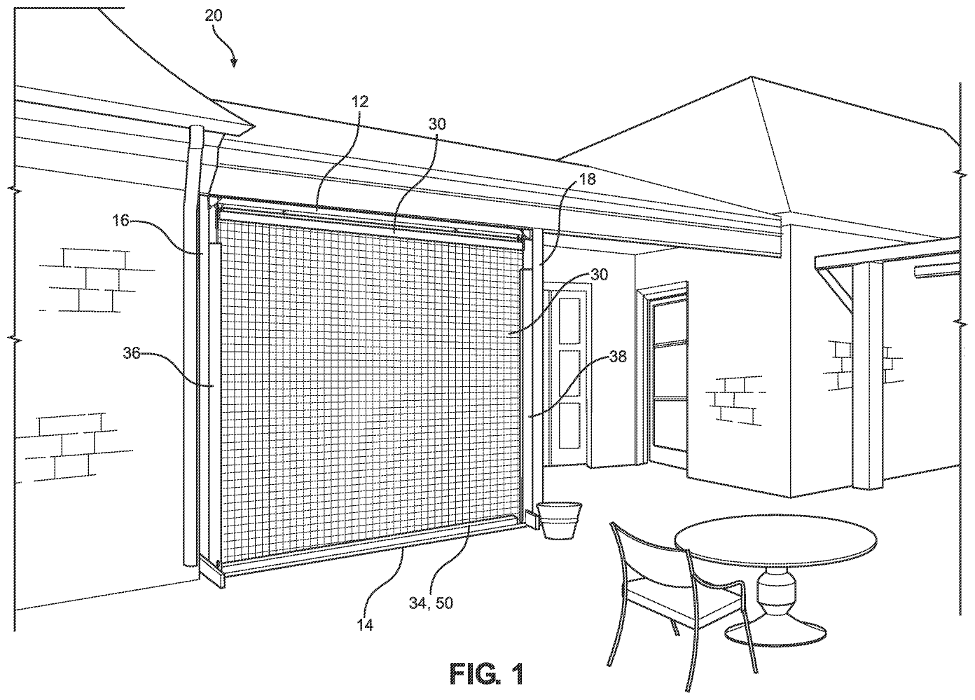

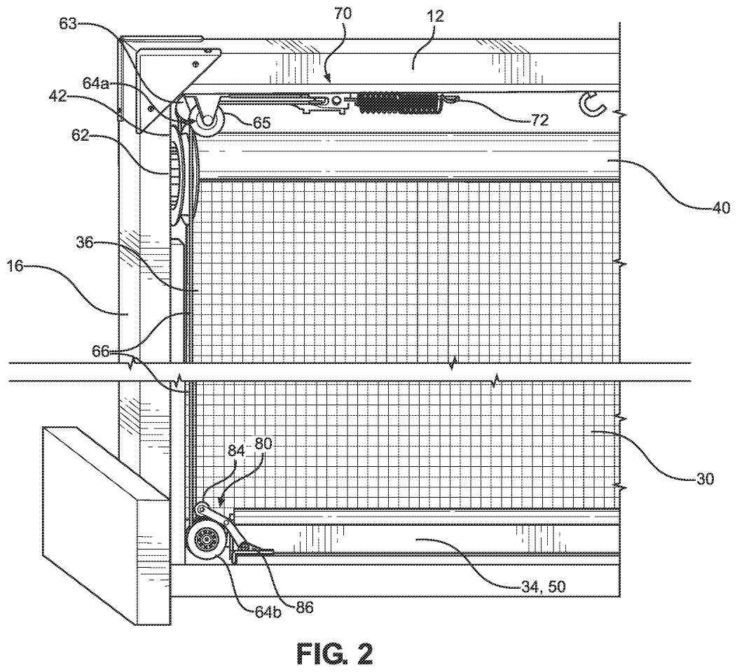

With reference to FIGS. 1-2, a motorized retractable screen system 20 according to one embodiment of the present disclosure is depicted. In operation, the screen system 20 move a screen 30 between a deployed position and a retracted position within a framed area. For purposes of the present disclosure, a “screen” is intended to broadly encompass any type of movable partition made from any number of different materials such as mesh insect screens, shade screens, privacy screens, clear vinyl screens, television projector screens, etc. The framed area in which the screen system 20 is installed is preferably a porched or outdoor patio area but may also include countless other open areas such as doorways, windows, garages, a wall portion in which a tv projection screen is intended to be deployed, etc.

With reference specifically to FIG. 1, the framed area generally includes a first end 12 (e.g., top end in FIG. 1), a second end 14 opposite the first end 12 (e.g., bottom end in FIG. 1), a first side 16 (e.g., left side in FIG. 1), and a second side 18 (e.g., right side in FIG. 1). In certain embodiments, the framed area is specifically designed for installation of the retractable screen system 20. In other embodiments, certain portions of the framed area may be formed from existing structures such as walls, ceilings, columns, floors, decking, etc. Similar to the framed area, the screen 30 also includes a corresponding first end 32, a second end 34, a first side 36, and a second side 38. The screen 30 is dimensioned and configured to cover the opening of the framed area in the deployed position and provide access to the opening of the framed area in the retracted position. In preferred embodiments, the motorized screen system 20 is operable to selectively position the screen 30 anywhere between the deployed position and the retracted position.

With reference to FIG. 2, the first end 32 of the screen 30 is connected to a screen axle 40 positioned adjacent the first end 22 of the framed area. The second end 34 of the screen 30 is secured to a weighted bottom bar 50. The motorized retractable screen system 20 of this embodiment further includes a drive system 60 that generally includes a motor 62, a cable and pulley system, and a track system in which the screen 30 travels. More specifically, according to the embodiment shown, the drive system 60 includes a motor 62 configured to drive/rotate the screen axle 40. A spool 42 is operatively connected to each side of the screen axle 40 such that the screen axle 40 and the spools 42 are configured to rotate together when driven by the motor 62. The cable and pulley system operates to drive the screen 30 and bottom bar 50 along a track (not shown) disposed at the sides 16, 88 of the framed area when the spools 42 are rotated. In this regard, adjacent each of the first side 16 and second side 18 of the framed area (the first side 16 being shown in FIG. 2), the first end of a cable 66 is operatively connected to the spool 42. The cable 66 is then wound at least partially around the spool 42 (in the opposite direction in which the screen is intended to be wound around the screen axle 40) and through a series of pulleys 64 with the second end of the cable 66 then operatively connected to the bottom bar 50. As a result, a closed loop system is formed preferably on both sides of the screen 30 with (1) the first end of the cable 66 being operatively connected to the spool 42; (2) the second end of the cable 66 being operatively connected to the bottom bar 50 (which is operatively connected to the second end 34 of the screen 30 as noted above); (3) the first end 32 of the screen 30 being operatively connected to the screen axle 40; and (4) the screen axle 40 and spool 42 being operatively connected such that rotation of the screen axle 40 also rotates the spool 42. For purposes of the present disclosure, “operatively connected” could refer to a direct connection (e.g., the spool 42 connected directly to the screen axle 40) or to an indirect connection via one or more intermediate parts (e.g., the second end of the cable 66 is connected to the bottom bar 50 via a tensioner arm as explained further below).

In operation, the motor 62 operates to rotate the screen axle 40 and corresponding spools 42 in either a first direction or a second direction. Force is translated from the torque of the motor to the bottom bar 50 at the second end 34 of the screen 30 to pull the screen 30 in a desired direction along the tracks. When rotated in the first direction, the cables 66 are wound around the spools 42 (i.e., the length of the cables 66 is shortened) such that the cables 66 pull the bottom bar 50 towards the deployed position while the screen 30 is being unwound from the screen axle 40. In the second direction, the cables 66 are being unwound from the spools 42 (i.e., the length of the cables 66 is increased) such that the cables 66 pull the bottom bar 50 of the screen 30 towards the retracted position while the screen 30 is being wound back around the screen axle 40.

With continued reference to FIG. 2, the drive system 60 is designed to maintain tension to both sides of the screen 30 during movement between the retracted and deployed positions. In this regard, the drive system 60 preferable utilizes, on each side of the screen 30, a first pulley system 64a located adjacent to the spool 42 at the first end 12 of the framed area and then a corresponding second pulley system 64b located at the second end 14 of the framed area. The spools 42, first pulley system 64a, and second pulley system 64b operate to create a tension field along the sides 36, 38 of the screen 30 that is directly proportional to the tension in the cables 66.

According to another aspect of the disclosure, and with continued reference to FIG. 2, the first pulley system 64a for each cable 66 may further include a tensioning system for further assisting in maintaining tension of the cable 66 (and therefore maintaining tension in the screen 30). According to this embodiment, the first pulley system 64a includes a first pulley 63 and second pulley 65 positioned along the first end 12 of the framed area. The cable 66 extends from the spool 42 around the first pulley 63 to a tensioning spring system 70 and then back through the second pulley 65. From the second pulley 65 of the first pulley system 64a, the cable 66 then extends along the respective side 16, 18 of the framed area and around the second pulley system 64b to be connected to the bottom bar 50. Tensioning spring system 70 helps to maintain tension to the cable 66 where the tension in the cable is determined by the force of the tensioning spring 72 of the tensioning spring system 70. The tensioning spring 72 could be an extension spring, a compression spring, torsion spring and accommodating swingarm-mounted pulley, or any other spring known in the art that is able to maintain tension on the cable 66. The tensioning spring system 70 is intended to benefit from selection of a generally low rate spring 72 so that force does not vary significantly throughout movement of the screen 30. The positioning of the tensioning spring system 70 (or components thereof) may also be adjustable with respect to the frame to modify tensioning charactistics as needed (such as during installation).

With respect to the tensioning spring system 70, the diameter of the spools 42 are preferably of a similar diameter to that of the screen axle 40. This helps to ensure that the tension of the spring 72 does not vary significantly over the range of travel of the screen 30, and therefore the tension of the cable 66 also does not vary significantly. It is also noted that the diameter of the spools 42 and screen axle 40 change slightly during operation of the system 20 as a result of the screen 30 being wound/unwound from the screen axle 40 and the cable 66 being unwound/wound from the corresponding spools 42. This may be accounted for in varying ways including the selection of particular thicknesses of the screen 30 and cable 66 to help ensure the force of the spring 72 of the tensioning spring system 70 does not vary significantly during the movement of the screen 30. In particular, according to certain embodiments, the thickness of the screen 30 and cable 66 may be selected so that the necessary spring tension of spring 72 is at a maximum when the screen 30 is fully deployed.

According to another aspect of the disclosure, and with reference initially to FIG. 2, the drive system 60 preferably includes a corner tensioning system 80 for maintaining tension on the screen 30 by maintaining a downward and outward force on both sides of the screen 30 (i.e., both sides of the screen 30 include separate corner tensioning systems 80). For purposes of the present disclosure, “downward” refers to a direction towards the second end 14 of the framed area and/or second end 34 of the screen though it should be understood that the actual direction may not be vertically downward such as when the screen 30 is intended to move horizontally within the framed area instead of vertically). According to this embodiment, the corner tensioning system 80 includes a tensioning arm 82 having a first end 84 and a second end 86. The first end 84 of the tensioning arm 82 is operatively connected to the screen 30 adjacent one of the corners of the second end 34 of the screen 30. The second end 86 of the tensioning arm 82 is then operatively connected to the bottom bar 50. The cable 66 that extends from the second pulley system 64b is then operatively connected to the tensioning arm 82 to connect the cable 66 to the screen 30/bottom bar 50 via the tensioning arm 82. As shown, the cable 66 is preferably connected to the tensioning arm 82 between the connection points of the first end 84 to the screen 30 and the second end 86 to the bottom bar 50. Further, in preferred embodiments and as shown in FIG. 2, the connection point of the first end 84 with the screen 30 is generally positioned in alignment with the second pulley system 64b (i.e. vertical alignment when the screen 30 is intended to move up/down or horizontal alignment when the screen 30 is intended to move in a horizontal direction). With the bottom bar 50 then extending somewhat below the second end 34 of the screen 30, the tensioning arm 82 preferably provides an oblique angle between the connection point with the screen 30 and the connection point with the bottom bar 50. This oblique angle between the connection points enhances the downward and outward force on the screen 30 created by the corner tensioning systems 80.

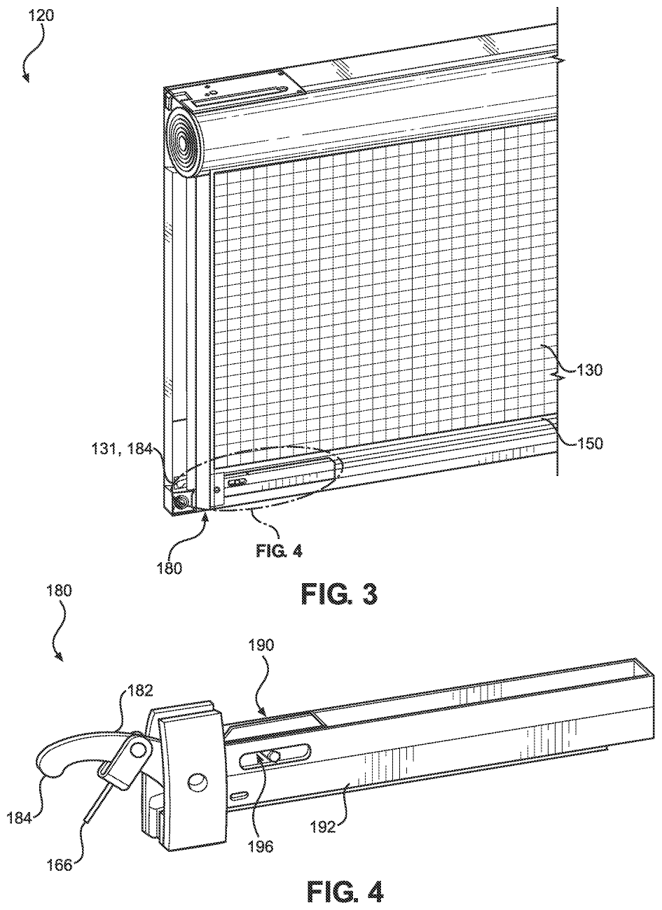

With reference to FIGS. 3-10, another embodiment of a corner tensioning system 180 for a motorized retractable screen system 120 is depicted. Similar to the embodiment of FIG. 2, the corner tensioning system 180 includes a tensioning arm 182 having a first end 184 and a second end 186. Cable 166 is operatively connected to the tensioning arm 182 between the first end 184 and the second end 186. According to this embodiment, the first end 184 is operatively connected to the screen 130 via being inserted into a stirrup 131 positioned at the lower corner of the screen 130 (e.g., a pocket sewn into the corner of the screen 130). However, any number of potential connections of the first end 184 to the screen 130 are also possible such as with rivets, fasteners, etc.

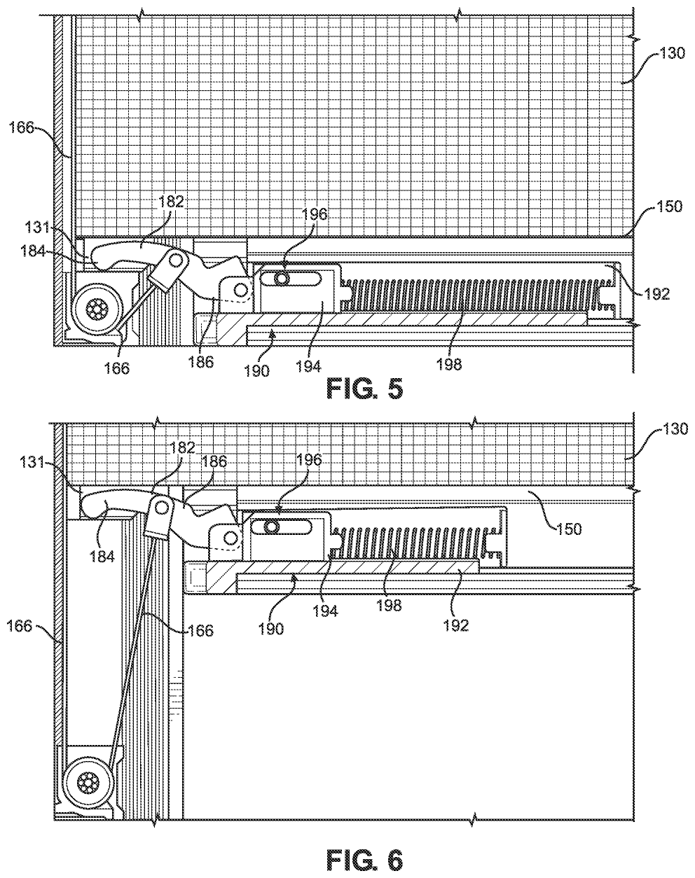

As shown best in FIG. 5-6, second end 186 of tensioning arm 182 is operatively connected to a tensioning assembly 190 disoposed within bottom bar 150. The tensioning assembly 190 is operable to provide a biased outward force to the second end 186 of the tensioning arm 182. While various forms of the tensioning assembly 190 are possible and intended to be within the scope of the present disclosure, tensioning assembly 190 of the embodiment shown includes a housing 192 secured within the bottom bar 150. A carriage 194 is disposed within the housing 192 such that it is operable to move laterally with respect to the bottom bar 150 and housing 192. In preferred embodiments, the carriage 194 is connected to the housing 192 such that it is able to slide within the limits of a pin and slot arrangement 196. The second end 186 of the tensioning arm is operatively connected to a first end of the carriage 194. A biasing means 198 (e.g., low rate compression spring) is then operatively connected to the second end of the carriage 194 to provide the biased outward force to the second end 186 of the tensioning arm 182.

With continued reference to FIG. 5 (which depicts the positioning of the bottom bar 150/screen 130 at the second end of the framed arca) and FIG. 6 (which depicts the positioning of the bottom bar 150/screen 130 in an intermediate retracted position as compared to FIG. 6), the cable 166 is preferably pivotally connected to the tensioning arm 182 such as with a clevis connection. This allows the angle of the cable 166 to be changed depending on the position of the bottom bar 150 with respect to the framed area and/or on the outward movement of the carriage 194 with respect to the bottom bar 150. Similarly, the stirrup 131 is preferably dimensioned and configured to allow small lateral movements or pivots of the first end 184 of the tensioning arm 182 while the second end 186 of the tensioning arm 182 is pivotally connected to the carriage 194 of the tensioning assembly 190.

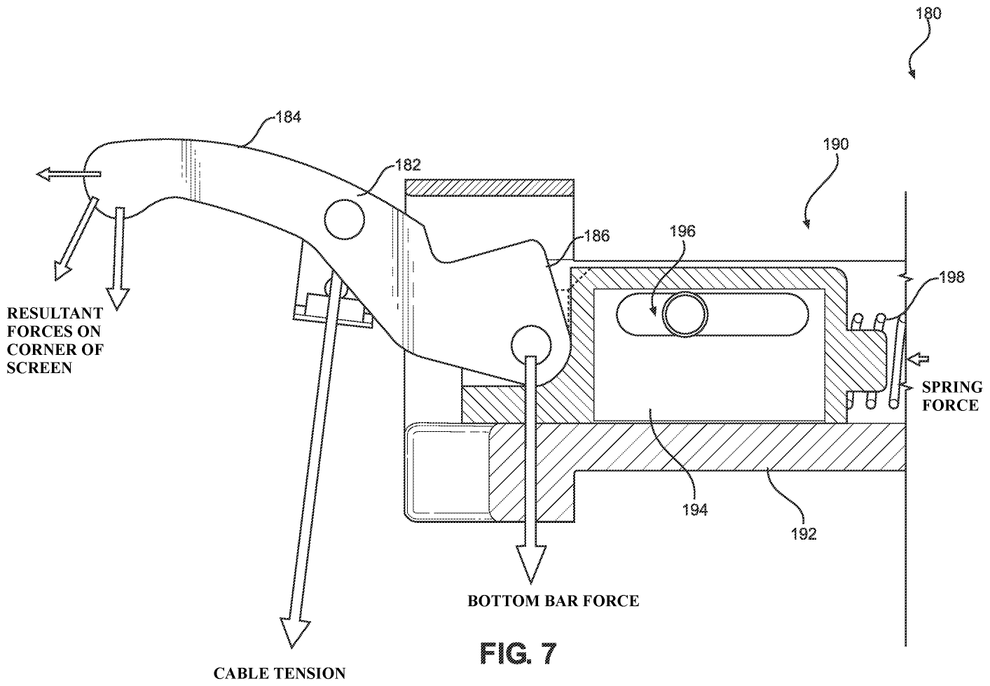

With reference to FIG. 7, corner tensioning system 180 maintains tension of the screen by providing a series of downward (assuming screen 130 is configured to move vertically within the framed area) and outward forces in the direction of the corresponding corner of the second end 24 of the framed area as depicted.

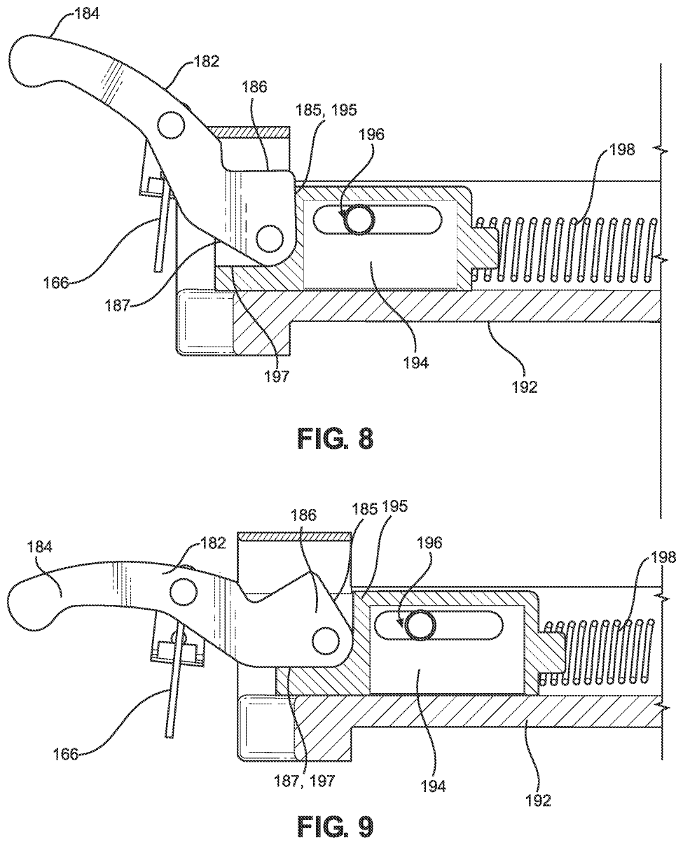

With reference to FIGS. 8 and 9, the second end 186 of the tensioning arm 182 and the corresponding end of the carriage 194 to which the tensioning arm is connected are preferably dimensioned and configured to limit upward and/or downward movement of the tensioning arm 182. According to this embodiment, the second end 186 of the tensioning arm includes a first stop edge 185 and second stop edge 187. The carriage 194 similarly includes a corresponding first stop edge 195 and second stop edge 197. The second end of the tensioning arm 182 is then pivotally connected to the carriage 194 such that the first stop edge 185 of the tensioning arm 182 engages the first stop edge 195 of the carriage 194 to limit movement of the tensioning arm 182 in a first rotational direction and the second stop edge 187 of the tensioning arm 182 engages the second stop edge 197 of the carriage to limit movement of the tensioning arm 182 in a second rotational direction.

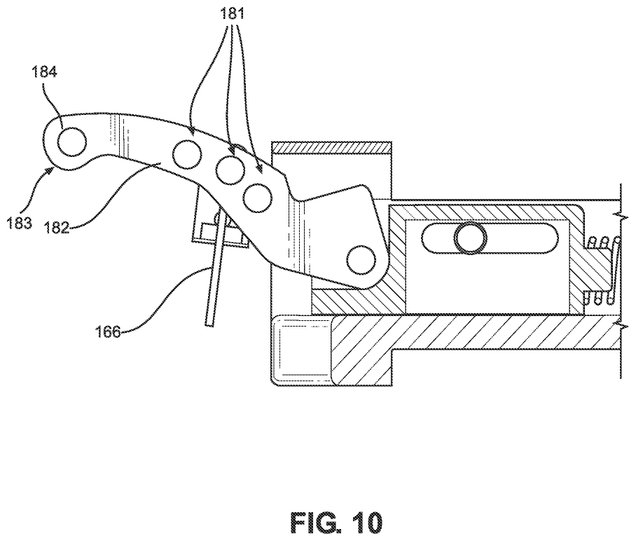

With reference to FIG. 10, the tensioning arm 182 may include a plurality of attachment positions 181 for altering the position of the attachment point between the cable 166 and the tensioning arm 182. The plurality of attachment positions 181 are available to easily and quickly change the proportion of downward-to-outward resultant force on the corner of the screen 130 without replacing the tensioning arm 182 or making changes to the tensioning assembly 190. FIG. 10 also shows an optional aperture 183 at the first end of the tensioning arm 182 for operatively connecting the tensioning arm to a corresponding aperture on the screen 130 with a grommet and associated hardware (e.g., screw, rivet, etc.).

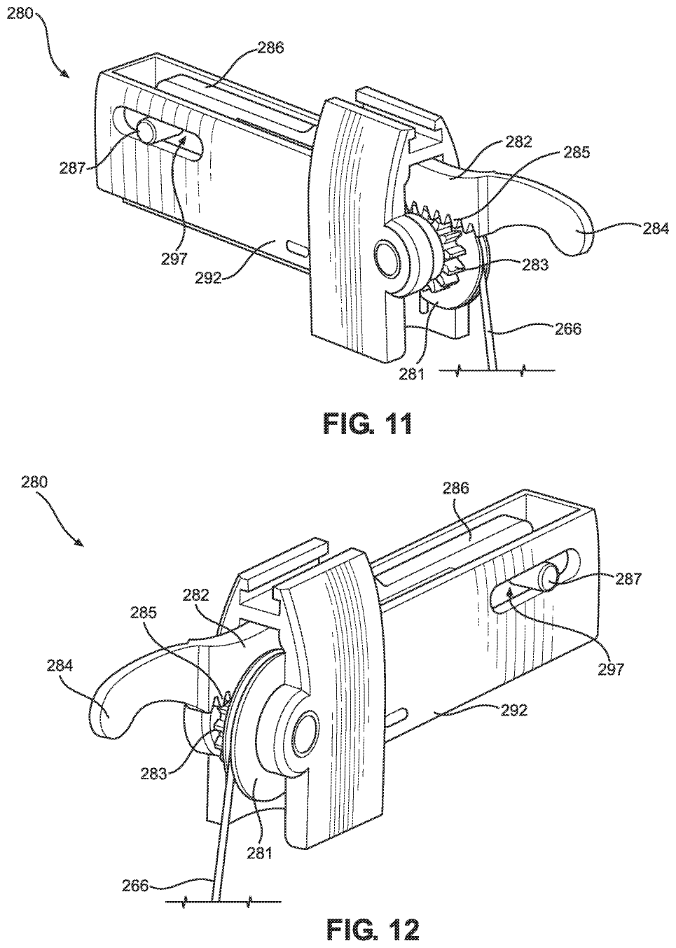

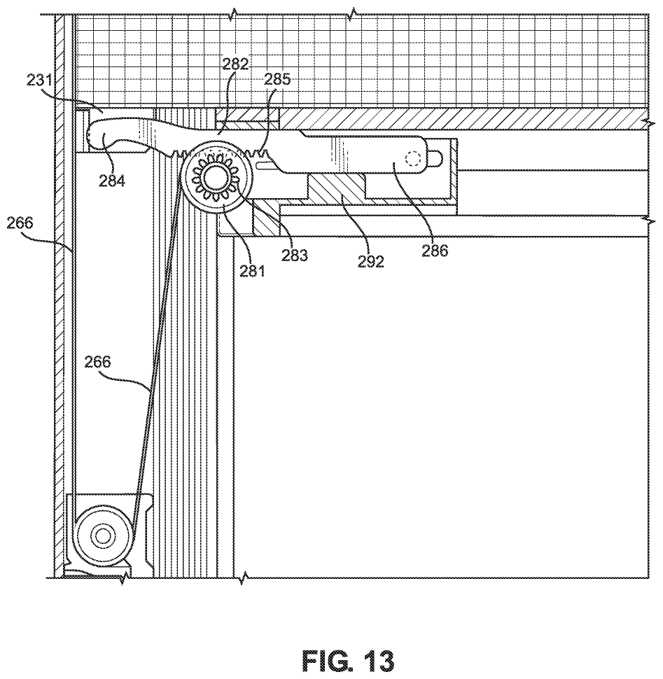

According to another embodiment of the disclosure, and with reference to FIGS. 11-13, corner tensioning system 280 of this embodiment includes a tensioning arm 282 that is configured to move laterally within housing 292 that is disposed within the bottom bar 250. According to this embodiment, the first end 284 of the tensioning arm 282 is operatively connected to the screen 230 as described above (e.g., within a stirrup 231 disposed at the corner of screen 230 as shown in the exemplary embodiment of FIG. 12). The second end 286 of the tensioning arm 282 is secured to the housing 292 such that the tensioning arm 282 is operable to move laterally with respect to the bottom bar 250. For example, in the embodiment shown, the second end 286 of the tensioning arm includes a pin 287 configured to slide within a slot 297 of the housing 292 with the amount of potential movement of the tensioning arm 282 being defined by the length of the slot 297.

In this embodiment, instead of being connected directly to the tensioning arm 282, the cable 266 is operatively connected to the tensioning arm 282 via a roller spool 281 that is connected to the housing 292. More specifically, the cable 266 extends from pulley 264 and is partially wrapped around and then connected to the roller spool 281. The roller spool 281 and tensioning arm 282 are positioned and configured with respect to the housing 292 such that gear teeth 283 of the roller spool 281 mesh with corresponding gear teeth 285 of the tensioning arm 282. In operation, the tension of the cable 266 creates torque on the roller spool 281. The torque on the roller spool 281 creates a rack-and-pinion action between the circular gear teeth 283 of the roller spool 281 and the linear gear teeth 285 of the tensioning arm 282. In other words, the torque applied to the roller spool 281 by the cable 266 results in lateral motion of the tensioning arm 282 such that the tensioning arm 282 is actively biased outward to maintain corresponding outward tension on the screen 230.

According to another aspect of this embodiment, the diameter of the spool 281 can be varied during installation and/or maintenance with larger diameter spools creating more outward push on the tensioning arm 282.

The foregoing description of preferred embodiments for this disclosure have been presented for purposes of illustration and description. They are not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by any claims when interpreted in accordance with the breadth to which they are fairly, legally, and equitably entitled.

What is claimed is:

1. A motorized retractable screen system comprising:
a screen axle disposed adjacent a first end of a framed area that is configured to be rotated by a motor;
at least one spool operatively connected to the screen axle such that the screen axle and the at least one spool are opereable to rotate together;
a cable including a first end and a second end, wherein the first end is at least partially wound around the at least one spool and wherein the cable is run through a series of pulleys between its first end and its second end, the series of pulleys including a first pulley system disposed adjacent the first end of the framed area and a second pulley system disposed adjacent the second end of the framed area;
a screen including a first end operatively connected to the screen axle, a second end operatively connected to a bottom bar, a first side, and a second side; and
a corner tensioning system including a tensioning arm having a first end configured to be operatively connected to a corner of the first side of the screen, a second end configured to be operatively connected to a first side of the bottom bar, and attachment means for operatively connecting to the second end of the cable;
wherein, the screen axle is operable to be rotated in either a first direction or a second direction by the motor such that the cable is operable to pull the bottom bar at the second end of the screen between a deployed position and a retracted position while the corner tensioning system maintains downward and outward tension on the screen.

2. The motorized retractable screen system of claim 1 wherein the corner of the first side of the screen includes a stirrup configured to receive the first end of the tensioning arm for operatively connecting the first end of the tensioning arm to the corner of the first side of the screen.

3. The motorized retractable screen system of claim 1 wherein the attachment means is configured to provide for a pivotable connection between the second end of the cable and the tensioning arm.

4. The motorized retractable screen system of claim 3 wherein the tensioning arm includes a plurality of attachment positions for altering the position of the pivotable connection between the second end of the cable and the tensioning arm.

5. The motorized retractable screen system of claim 3 wherein the attachment means includes a clevis connection for pivotally connecting the second end of the cable to the tensioning arm.

6. The motorized retractable screen system of claim 1 wherein the corner tensioning system includes a biasing means for providing a biased outward force to the second end of the tensioning arm.

7. The motorized retractable screen system of claim 6 wherein the corner tensioning system further includes a housing configured to be disposed within the bottom bar and a carriage disposed within the housing that is operable to move laterally with respect to the bottom bar and housing, wherein the biasing means is operatively connected to the carriage and the second end of the tensioning arm is operatively connected to the carriage such that the biasing means provides the biased outward force to the second end of the tensioning arm via the carriage.

8. The motorized retractable screen system of claim 7 wherein the second end of the tensioning arm is pivotally connected to a first end of the carriage.

9. The motorized retractable screen system of claim 8 wherein the second end of the tensioning arm includes a first stop edge and a second stop edge and the first end of the carriage includes a corresponding first stop edge and a second stop edge, and wherein the first stop edge of the tensioning arm is dimensioned and configured to engage the first stop edge of the carriage to limit movement of the tensioning arm in a first rotational direction and the second stop edge of the tensioning arm is dimensioned and configured to engage the second stop edge of the carriage to limit movement of the tensioning arm in a second rotational direction opposite the first rotational direction.

10. The motorized retractable screen system of claim 1 wherein the corner tensioning system further includes:
a housing configured to be disposed within the bottom bar, the second end of the tensioning arm being secured within the housing such that the tensioning arm is operable to move laterally with respect to the housing and the bottom bar; and
a roller spool operatively connected to the housing, the roller spool including a plurality of gear teeth configured to mesh with corresponding gear teeth of the tensioning arm,
wherein the roller spool is the attachment means for operatively connecting the second end of the cable to the tensioning arm and wherein a tension of the cable creates a torque on the roller spool resulting in a rack-and-pinion action between the gear teeth of the roller spool and the gear teeth of the tensioning arm such that the tensioning arm is biased outward to maintain tension on the screen.

11. A corner tensioning system for a motorized retractable screen system, the corner tensioning system comprising a tensioning arm having a first end configured to be operatively connected to a screen of the motorized retractable screen system, a second end configured to be operatively connected to a bottom bar of the motorized retractable screen system, and attachment means for operatively connecting a drive cable of the motorized retractable screen system to the tensioning arm between the first end and the second end.

12. The corner tensioning system of claim 11 wherein the attachment means is configured to provide for a pivotable connection between the drive cable and the tensioning arm.

13. The corner tensioning system of claim 12 wherein the tensioning arm includes a plurality of attachment positions for altering the position of the pivotable connection between the drive cable and the tensioning arm.

14. The corner tensioning system of claim 11 wherein the attachment means includes a clevis connection for pivotally connecting the drive cable to the tensioning arm.

15. The corner tensioning system of claim 11 further comprising a biasing means for providing a biased outward force to the second end of the tensioning arm.

16. The corner tensioning system of claim 15 further comprising a housing configured to be disposed within the bottom bar and a carriage disposed within the housing that is operable to move laterally with respect to the bottom bar and housing, wherein the biasing means is operatively connected to the carriage and the second end of the tensioning arm is operatively connected to the carriage such that the biasing means provides the biased outward force to the second end of the tensioning arm via the carriage.

17. The corner tensioning system of claim 16 wherein the second end of the tensioning arm is pivotally connected to a first end of the carriage.

18. The corner tensioning system of claim 17 wherein the second end of the tensioning arm includes a first stop edge and a second stop edge and the first end of the carriage includes a corresponding first stop edge and a second stop edge, and wherein the first stop edge of the tensioning arm is dimensioned and configured to engage the first stop edge of the carriage to limit movement of the tensioning arm in a first rotational direction and the second stop edge of the tensioning arm is dimensioned and configured to engage the second stop edge of the carriage to limit movement of the tensioning arm in a second rotational direction opposite the first rotational direction.

19. The corner tensioning system of claim 11 further comprising:
a housing configured to be disposed within the bottom bar, the second end of the tensioning arm being secured within the housing such that the tensioning arm is operable to move laterally with respect to the housing and the bottom bar; and
a roller spool operatively connected to the housing, the roller spool including a plurality of gear teeth configured to mesh with corresponding gear teeth of the tensioning arm,
wherein the roller spool is the attachment means for operatively connecting the drive cable to the tensioning arm and wherein a tension of the cable creates a torque on the roller spool resulting in a rack-and-pinion action between the gear teeth of the roller spool and the gear teeth of the tensioning arm such that the tensioning arm is biased outward to maintain tension on the screen.
